(19) United States
(12) Patent Application Publication
(10) Pub. No.: US 2013/0212870 A1
(43) Pub. Date: Aug. 22, 2013

(54) System and Method for Creating and Assembling Magnetic Poles in Permanent Magnet Electrical Machines

(71) Applicant: Jyoti Limited, (US)

(72) Inventor: Rahul Nanubhai Amin, Gujarat (IN)

(73) Assignee: JYOTI LIMITED, Gujarat (IN)

(21) Appl. No.: 13/773,040

(22) Filed: Feb. 21, 2013

(30) Foreign Application Priority Data
Feb. 21, 2012 (IN) 460/MUM/2012

(51) Int. Cl. H01F 41/00

(52) U.S. Cl. CPC H01F 41/00
USPC 29/602.1; 29/757

(57) ABSTRACT

A reliable, simple and cost effective system and method for creating at least one magnetic pole on an element of an electrical machine by assembling a plurality of magnets thereon is provided. The system comprises at least one magnetic pole creating apparatus including a non-magnetic frame; magnet guiding device mounted on the frame, the magnet guiding device comprising a reciprocating inner part provided with a magnet holding plate for holding the plurality of magnets and an outer part fixed to the frame; a jig removably fitted at a pre-determined location on the element, the jig is coupled to the non-magnetic frame; and a magnet receiving apparatus coupled to the jig and co-operating with the inner part for receiving and securing the plurality of magnets to the element of the electrical machine. The system also enables simultaneous assembly of a plurality of magnetic poles on the element of the electrical machine.

### CROSS-REFERENCE TO RELATED APPLICATIONS

This application claims the priority, under 35 U.S.C. §119, of Indian patent application No. 460/MUM/2012, filed Feb. 21, 2012; the prior application is herewith incorporated by reference in its entirety.

### STATEMENT REGARDING FEDERALLY SPONSORED RESEARCH OR DEVELOPMENT

Not Applicable

### FIELD OF THE INVENTION

The present invention lies in the field of electrical machines. In particular, the present disclosure relates to a system and method for creating and assembling magnetic poles in permanent magnet electrical machines.

### BACKGROUND OF THE INVENTION

In an electrical machine, usually a plurality of permanent magnets is assembled on a rotor body of an electrical machine. During assembling of permanent magnets on the rotor body, it is essential to fix permanent magnets precisely at specific positions on the rotor surface of the electrical machine in order to minimize torque ripple effects during operation of electrical machines.

The assembly of permanent magnet poles is required to be carried out with utmost care. Because repulsive forces between high energy permanent magnets of similar polarities are high, the positioning and fixing operation of the permanent magnet poles need complex, skilled and very costly assembling steps and devices.

Further, permanent magnets like rare earth magnets are fragile. During assembly of permanent magnets on the rotor, the permanent magnets are subjected to mechanical loads that may cause damage to the magnets and, hence, it is necessary to handle the magnets with utmost care. This critical handling requirement increases the cost of the method and tools for assembling permanent magnets on the rotor body of an electrical machine.

Thus, a need exists to overcome the problems with the prior art systems, designs, and processes as discussed above.

### SUMMARY OF THE INVENTION

The invention provides a system and method for creating and assembling magnetic poles in permanent magnet electrical machines that overcome the hereinafore-mentioned disadvantages of the heretofore-known devices and methods of this general type and that provide such features with ameliorating one or more problems of the prior art or to at least provide a useful alternative are described herein below.

With the foregoing and other objects in view, there is provided, in accordance with the invention, a system for creating magnetic poles.

With the objects of the invention in view, there is also provided a system for assembling magnetic poles precisely on the rotor of an electrical machine.

With the objects of the invention in view, there is also provided a cost effective system for creating and assembling magnetic poles on the rotor of an electrical machine.

With the objects of the invention in view, there is also provided a simple method for creating and positioning magnetic poles on the rotor of an electrical machine.

With the objects of the invention in view, there is also provided a cost effective method for creating and positioning magnets on the rotor of an electrical machine.

With the objects of the invention in view, there is also provided a method for assembling a plurality of magnetic poles simultaneously.

With the objects of the invention in view, there is also provided a reliable system and method for creating and positioning magnetic poles on the rotor of an electrical machine.

Other objects and advantages of the present disclosure will be more apparent from the following description when read in conjunction with the accompanying figure, which is not intended to limit the scope of the present disclosure.

In accordance with the present disclosure, there is provided a system for creating a magnetic pole on an element of an electrical machine by assembling a plurality of magnets thereon, the system comprising:
at least one magnetic pole creating apparatus comprising:
   a non-magnetic frame;
   magnet guiding device or means mounted on the frame, the magnet guiding device or means comprising:
      a reciprocating inner part provided with a magnet holding plate adapted to hold the plurality of magnets; and
      an outer part fixed to the frame;
a jig removably fitted at a pre-determined location on the element, the jig adapted to be coupled to the non-magnetic frame; and
a magnet receiving apparatus coupled to the jig and adapted to co-operate with the inner part for receiving and securing the plurality of magnets to the element of the electrical machine.

Additionally, the system for creating a magnetic pole, in accordance with the present disclosure further comprises a driver coupled to the magnet guiding device or means to provide translational motion to the reciprocating inner part in a to and fro direction along a predefined axis of motion, the driver being further coupled to a gear mechanism.

Typically, the driver is selected from the group consisting of electrical motors, hydraulic motors and pneumatic motors.

Optionally, the system for creating a magnetic pole further comprises at least one magnet pressing assembly adapted to firmly secure the plurality of magnets within the magnet receiving apparatus, the magnet pressing assembly comprising a pressing device or pressing means having a first end coupled to the jig and a second end coupled to holder or holding means mounted on a non-magnetic platform of the electrical machine, the pressing device or pressing means comprising a plurality of threaded bolts, each of the bolts being associated with a magnet from the plurality of magnets.

Typically, the magnetic pole is a permanent magnet pole.

Typically the element referred herein above is a rotor of the electrical machine.

In accordance with the present disclosure, the element of the electrical machine is preferably coated with at least one layer of adhesive to enable secured fastening of the magnetic poles thereon.

Typically, the magnet receiving apparatus comprises a plurality of removable vertical and horizontal separators adapted to create a plurality of cavities configured to receive the plurality of magnets therein.

In accordance with the present disclosure, there is provided a method for creating a magnetic pole on an element of an electrical machine by assembling a plurality of magnets thereon, the method comprising the following steps:
applying adhesive on the surface of the element;
removably fitting at least one jig at a predetermined location on the surface of the element;
defining a plurality of cavities by removable vertical and horizontal separators provided within a magnet receiving apparatus;
coupling the magnet receiving apparatus to the jig;
providing at least one magnetic pole creating apparatus with a non-magnetic frame;
mounting a magnet guiding device or means on the non-magnetic frame;
placing a plurality of magnets onto a magnet holding plate provided in a reciprocating inner part of the magnet guiding device or means;
fixing an outer part of the magnet guiding device or means to the frame;
coupling the jig to the frame;
providing translational motion to the reciprocating inner part in a to and fro direction along a predefined axis of motion;
guiding each magnet of the plurality of magnets into a corresponding cavity in the plurality of cavities; and
decoupling the magnetic pole creating apparatus after a predetermined time.

In accordance with an embodiment, the method for creating and assembling at least one magnetic pole, described herein above, further comprises the following steps:
pressing each magnet of the plurality of magnets on to the surface of the element, by a magnet pressing assembly, for either a predetermined time or until the adhesive gets cured and forming a single magnetic pole;
removing the vertical separators;
decoupling the magnet pressing assembly;
removing the horizontal separators; and
decoupling the jig and the magnet receiving apparatus.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 illustrates a perspective view of a magnetic pole creating apparatus in accordance with the present disclosure;

FIG. 2 illustrates a side elevational view of the apparatus of FIG. 1;

FIG. 3 illustrates a perspective view of a schematic representation of a rotor of an electrical machine with a non-magnetic platform;

FIG. 4 illustrates a fragmentary, perspective view of a schematic representation of a section of the rotor of FIG. 3 illustrating a jig and a magnet receiving apparatus;

FIG. 5 illustrates details of the magnet receiving apparatus of FIG. 4;

FIG. 6 illustrates a fragmentary, perspective view of a schematic representation of a section of the rotor of FIG. 3 with the apparatus of FIG. 1;

FIG. 7 illustrates a fragmentary, perspective view of a schematic representation of a section of the rotor of FIG. 3 with a magnet pressing assembly;

FIG. 8 illustrates a fragmentary, perspective view of a schematic representation of the rotor of FIG. 3 with a plurality of the apparatus of FIG. 1;

FIG. 9 illustrates a fragmentary, perspective view of a schematic representation of a portion of the rotor of FIG. 3 with a magnetic pole precisely positioned on it;

FIG. 10 illustrates a perspective view of a magnet guiding device or means constituting the apparatus of FIG. 1; and

FIG. 11 illustrates an exploded perspective view of the magnet pressing assembly of FIG. 7.

### DETAILED DESCRIPTION OF THE INVENTION

The system and method for creating and assembling magnetic poles in accordance with the present disclosure will now be described in detail with reference to the accompanying drawings. The preferred embodiment does not limit the scope and ambit of the disclosure. The description provided is purely by way of example and illustration.

The embodiment herein and the various features and advantageous details thereof are explained with reference to the non-limiting embodiment in the following description. Description of well-known components and processing techniques are omitted so as to not unnecessarily obscure the embodiment herein. The examples used herein are intended merely to facilitate an understanding of ways in which the embodiment herein may be practiced and to further enable those of skill in the art to practice the embodiment herein. Accordingly, the example should not be construed as limiting the scope of the embodiment herein.

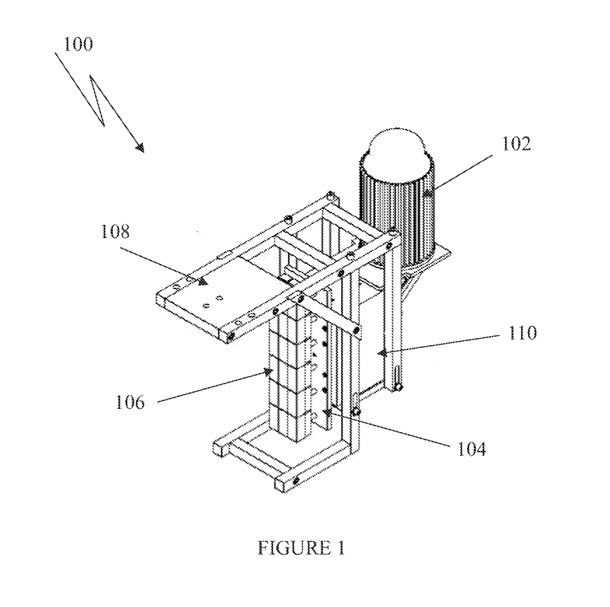

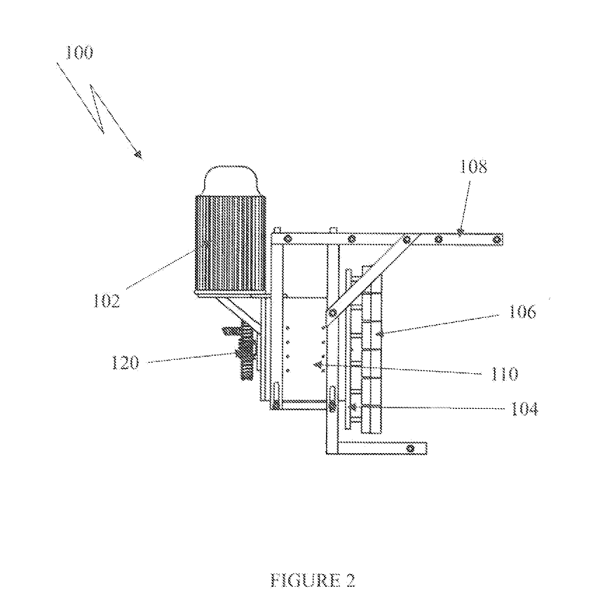

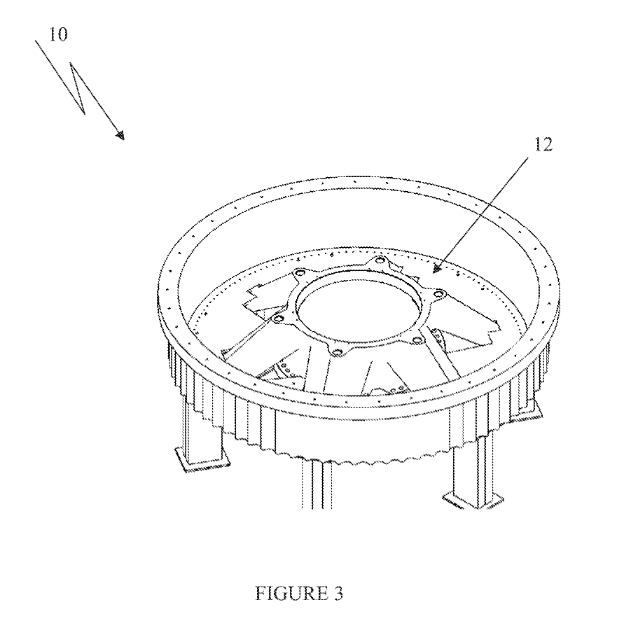

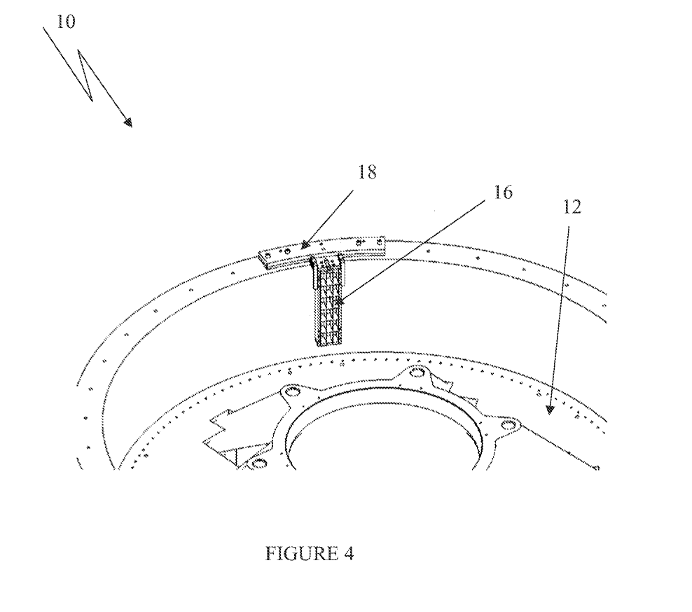

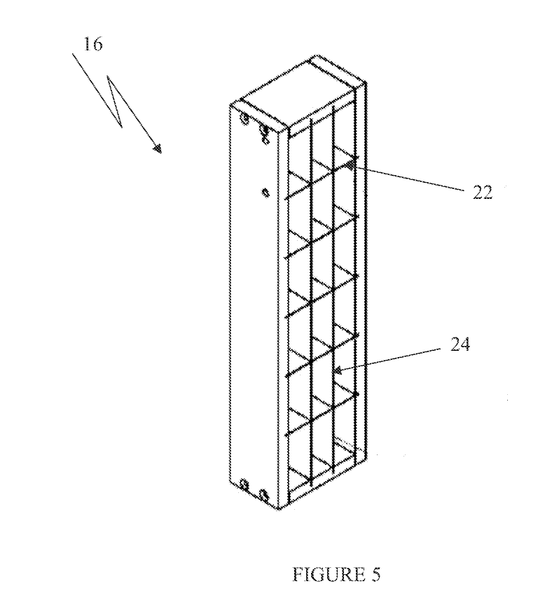

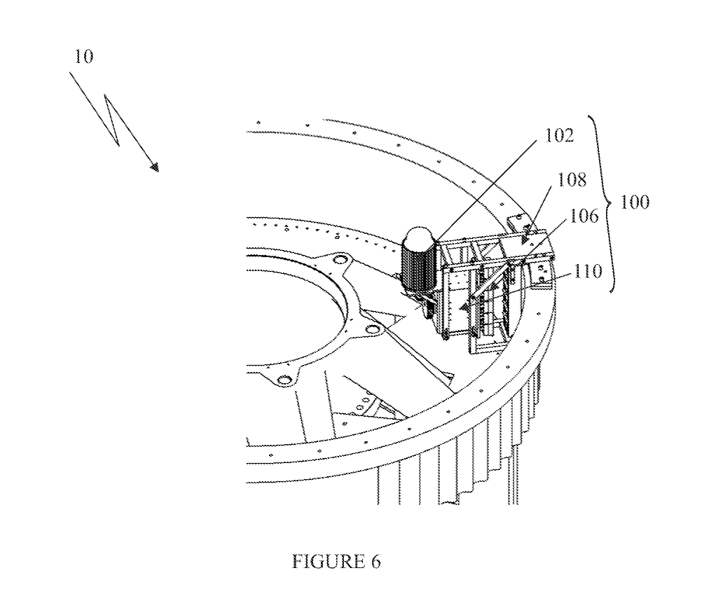

The system and method for creating and assembling magnetic poles in accordance with the present disclosure will now be explained with reference to FIG. 1 to FIG. 11 with the key components being generally referenced by numerals as illustrated.

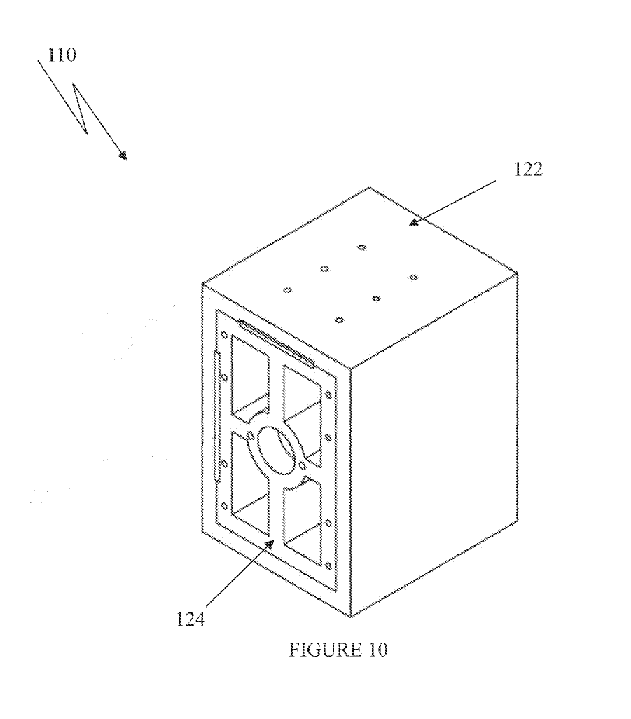

The magnetic pole creating apparatus 100 of the present disclosure typically comprises the following key components:
a non-magnetic frame 108 for coupling the apparatus 100 to a rotor 10 of an electrical machine;
an auxiliary equipment 102 for providing rotational motion is fixed to the frame 108;
a gear mechanism 120 is coupled to the auxiliary equipment 102 for converting rotational motion provided by the auxiliary equipment 102 to translational motion;
a magnet guiding device or magnet guiding means 110 (see FIG. 10) is mounted on the frame 108 for supporting the apparatus 100, the magnet guiding device 110 comprises a reciprocating inner part 124 and an outer part 122 fixed to the frame 108; and
a magnet holding plate 104 for holding a plurality of magnets 106 (typically rectangular shaped NdFeB permanent magnets) is coupled to the inner part 124.

The inner part 124 is movable along the axis of a shaft coupled to the shaft of the auxiliary equipment 102 via the gear mechanism 120, thus enabling motion of the magnet holding plate 104 in a to and fro direction for precise positioning of the magnets 106 on to the rotor 10. Typically, the auxiliary equipment 102 is either a geared three phase motor or pneumatic or hydraulic equipment. When the auxiliary equipment 102 is a geared three phase motor, a switch is provided to control the direction of rotation (either in clockwise or anticlockwise) of the motor.

In accordance with an embodiment of the present disclosure, the gear mechanism 120 is a rack and pinion arrangement. The rack is coupled to the shaft of the auxiliary equipment 102 and the pinion is coupled to the magnet guiding device 110 for movement of the magnet guiding device 110 along with its axis, thus enabling motion of the magnet holding plate 104 in a to and fro direction for precise positioning of the magnets 106 on to the rotor 10.

The rotor 10 with a non-magnetic platform 12 is provided with a plurality of jigs 18 and magnet receiving apparatus 16 at predefined locations for precisely securing the magnets 106 on to the rotor 10 of the electrical machine. The platform 12 serves as a working space and is typically a wooden platform. The magnet receiving apparatus 16 is provided with a plurality of horizontal separators 22 and vertical separators 24 made up of non-magnetic material to provide precisely guide and locate the magnets 106 on to the rotor 10.

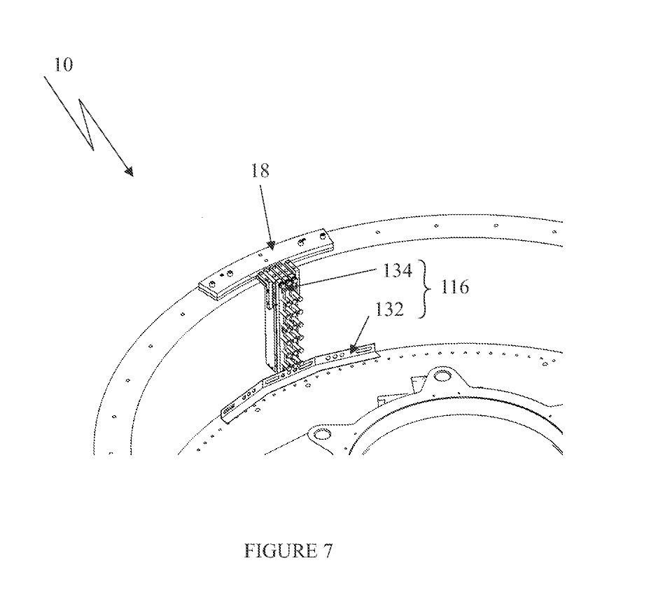

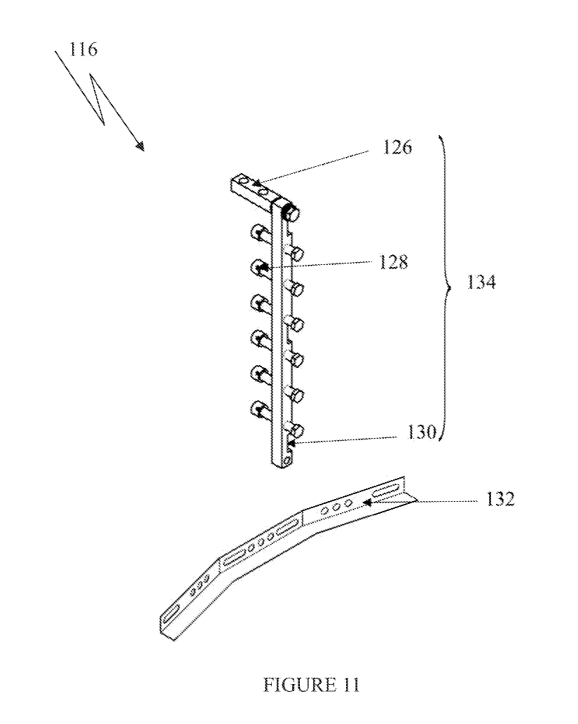

A magnet pressing assembly 116 (see FIG. 7) having a pressing device or pressing means 134 and a holder or holding means 132 is provided for further securing the precisely located magnets 106 on the rotor 10. The holder 132 is mounted on the platform 12. The pressing device 134 is mounted on the jig 18 through a mounting device or mounting means 126 (see FIG. 11). The pressing device 134 is provided with a plurality of threaded bolts 128 to press and hold the magnets 106 at their respective positions on the rotor 10 of the electrical machine. Each threaded bolt 128 corresponds to a magnet in the plurality of magnets 106. The pressing device 134 is further provided with a groove 130 to support the pressing device 134 by locking the holder 132 therein. The number of magnet pressing assembly 116 depends on the number of columns of magnets 106 in one pole.

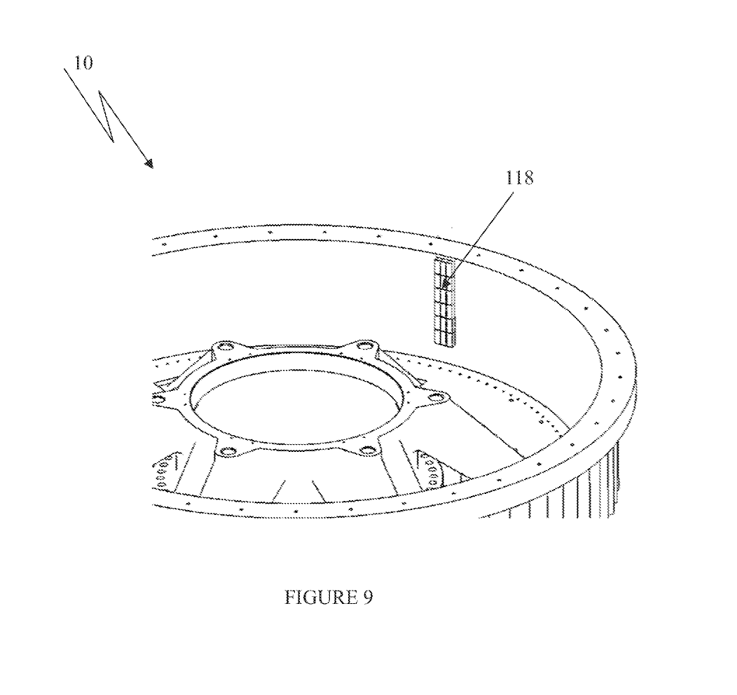

In accordance with the present disclosure, a method for creating a magnetic pole 118 on to the rotor 10 of the electrical machine (see FIG. 9) by assembling a plurality of magnets 106 typically comprises the following steps:
applying adhesive on the surface of the rotor 10 of the electrical machine;
removably fitting at least one jig 18 at a predetermined location on the surface of the rotor 10 of the electrical machine;
defining a plurality of cavities by removable vertical 24 and horizontal separators 22 provided within a magnet receiving apparatus 16;
coupling the magnet receiving apparatus 16 to the jig 18;
providing at least one magnetic pole creating apparatus 100 with the non-magnetic frame 108;
mounting a magnet guiding device 110 on the non-magnetic frame 108;
placing a plurality of magnets 106 onto a magnet holding plate 104 provided in a reciprocating inner part 124 of the magnet guiding device 110;
fixing an outer part 122 of the magnet guiding device 110 to the frame 108;
coupling the jig 18 to the frame 108;
providing translational motion to the reciprocating inner part 124 in a to and fro direction along a predefined axis of motion;
guiding each magnet 106 of the plurality of magnets into a corresponding cavity in the plurality of cavities; and
decoupling the magnetic pole creating apparatus 100 after a predetermined time.

In accordance with an embodiment, the method for creating and assembling at least one magnetic pole, described herein above, further comprises the following steps:
pressing each magnet 106 of the plurality of magnets on to the surface of the rotor 10 of the electrical motor with a magnet pressing assembly 116 for either a predetermined time or until the adhesive gets cured and forming a single magnetic pole 118;
removing the vertical separators 24;
decoupling the magnet pressing assembly 116;
removing the horizontal separators 22; and
decoupling the jig 18 and the magnet receiving apparatus 16.

The process herein above provides a single pole 118 made up of a plurality of permanent magnets 106. In accordance with an embodiment of the present disclosure, every time the magnet holding plate 104 moves towards the rotor 10, at least one permanent magnet 106 is fixed to the rotor 10 of the electrical machine.

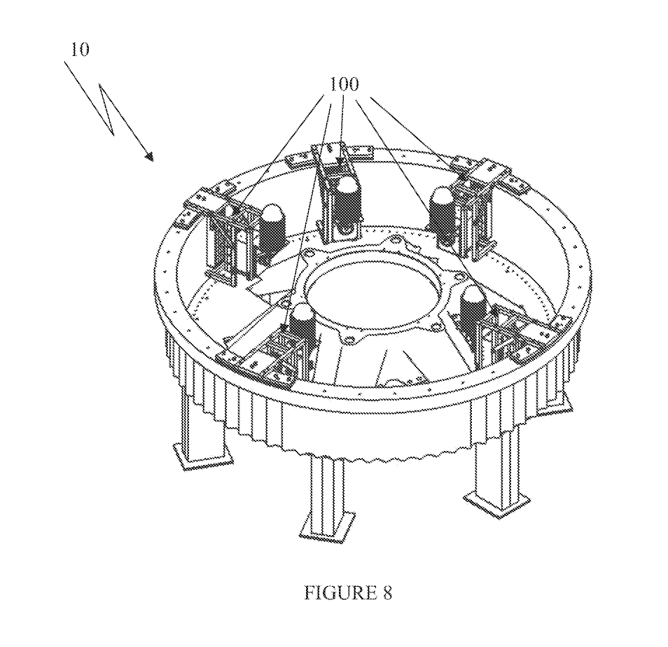

Although, the method herein above is described with reference to creating and assembling a single pole 118 (illustrated in FIG. 9) on the rotor 10 using a magnetic pole creating apparatus 100, the scope of the method of the disclosure is not limited to creating and assembling a single pole 118 and can be employed to create and assemble multiple poles simultaneously on the rotor 10 of an electrical machine using a plurality of magnetic pole creating apparatus 100 as shown, for example, in FIG. 8. Also, the application of the system and method described herein above can be extended to any element of an electrical machine and is not restricted to a rotor only.

### TECHNICAL ADVANCEMENTS AND ECONOMIC SIGNIFICANCE

The technical advancements offered by the apparatus and method of the present disclosure include the realization of:
a system for creating magnetic poles;
a system for assembling magnetic poles precisely on the rotor of an electrical machine;
a cost effective system for creating and assembling magnetic poles on the rotor of an electrical machine;
a simple method for creating and positioning magnetic poles on the rotor of an electrical machine;
a cost effective method for creating and positioning magnets on the rotor of an electrical machine;
a method for assembling a plurality of magnetic poles simultaneously; and
a reliable system and method for creating and positioning magnetic poles on the rotor of an electrical machine.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like that has been included in this specification is solely for the purpose of providing a context for the disclosure. It is not to be taken as an admission that any or all of these matters form part of the prior art base or were common general knowledge in the field relevant to the disclosure as it existed anywhere before the priority date of this application.

The foregoing description of the specific embodiment will so fully reveal the general nature of the embodiments herein that others can, by applying current knowledge, readily modify and/or adapt for various applications such specific embodiment without departing from the generic concept, and, therefore, such adaptations and modifications should and are intended to be comprehended within the meaning and range of equivalents of the disclosed embodiment. It is to be understood that the phraseology or terminology employed herein is for the purpose of description and not of limitation. Therefore, while the embodiment herein have been described in terms of preferred embodiment, those skilled in the art will recognize that the embodiment herein can be practiced with modification within the spirit and scope of the embodiment as described herein.

What is claimed is:

1. A system for creating a magnetic pole on an element of an electrical machine by assembling a plurality of magnets thereon, the system comprising:
at least one magnetic pole creating apparatus comprising:
a non-magnetic frame;
magnet guiding device mounted on said frame, said magnet guiding device comprising:
a reciprocating inner part provided with a magnet holding plate adapted to hold the plurality of magnets; and
an outer part fixed to said frame;
a jig removably fitted at a pre-determined location on the element, said jig adapted to be coupled to said non-magnetic frame; and
a magnet receiving apparatus coupled to said jig and adapted to co-operate with said inner part to receive and secure the plurality of magnets to the element of the electrical machine.

2. The system according to claim 1, further comprising:
a gear mechanism; and
a driver coupled to said magnet guiding device to provide translational motion to said reciprocating inner part in a to and fro direction along a predefined axis of motion, said driver being further coupled to said gear mechanism.

3. The system according to claim 1, further comprising a driver coupled to said magnet guiding device to provide translational motion to said reciprocating inner part in a to and fro direction along a predefined axis of motion, said driver being selected from the group consisting of electrical motors, hydraulic motors, and pneumatic motors.

4. The system according to claim 1, further comprising:
a holding device adapted to be mounted on a non-magnetic platform of the electrical machine; and
at least one magnet pressing assembly adapted to firmly secure the plurality of magnets within said magnet receiving apparatus, said magnet pressing assembly comprising a pressing device having a first end coupled to said jig and a second end coupled to said holding device, said pressing device comprising a plurality of threaded bolts, each of said bolts being associated with a magnet from the plurality of magnets.

5. The system according to claim 1, wherein the magnetic pole is a permanent magnet pole.

6. The system according to claim 1, wherein the element is a rotor of the electrical machine.

7. The system according to claim 1, wherein the element of the electrical machine is coated with at least one layer of adhesive applied thereon.

8. The system according to claim 4, further comprising an adhesive operable to coat the element of the electrical machine with at least one layer and, thereby, retain the plurality of magnets thereat when the pressing device is actuated to press the plurality of magnets.

9. The system according to claim 1, wherein said magnet receiving apparatus comprises a plurality of removable vertical and horizontal separators adapted to create a plurality of cavities configured to receive the plurality of magnets therein.

10. A method for creating a magnetic pole on an element of an electrical machine by assembling a plurality of magnets thereon, the method comprising the following steps:
applying adhesive on a surface of the element;
removably fitting at least one jig at a predetermined location on the surface of the element;
defining a plurality of cavities with removable vertical and horizontal separators provided within a magnet receiving apparatus;
coupling said magnet receiving apparatus to said jig;
providing at least one magnetic pole creating apparatus with a non-magnetic frame;
mounting a magnet guiding device on said non-magnetic frame, the magnet guiding device having an outer part and a reciprocating inner part;
placing the plurality of magnets onto a magnet holding plate provided in said reciprocating inner part of said magnet guiding device;
fixing said outer part of said magnet guiding device to said frame;
coupling said jig to said frame;
providing translational motion to said reciprocating inner part in a to and fro direction along a predefined axis of motion;
guiding each magnet of said plurality of magnets into a corresponding cavity in said plurality of cavities; and
decoupling said magnetic pole creating apparatus after a predetermined time.

11. The method according to claim 10, further comprising the following steps:
pressing each magnet of said plurality of magnets on to the surface of the element with a magnet pressing assembly for one of a predetermined time and until said adhesive is cured and forming a single magnetic pole;
removing said vertical separators;
decoupling said magnet pressing assembly;
removing said horizontal separators; and
decoupling said jig and said magnet receiving apparatus.
